(19) United States
(12) Patent Application Publication
(10) Pub. No.: US 2004/0225522 A1
(43) Pub. Date: Nov. 11, 2004

(54) ELECTRONIC ORDERING AND ALERT SYSTEM FOR HAIR REPLACEMENT INDUSTRY

(76) Inventors: Gerald McCaig, Dearborn Heights, MI (US); Martin Trifonov, Auburn Hills, MI (US)

(21) Appl. No.: 10/770,023

(22) Filed: Feb. 2, 2004

(51) Int. Cl. G06F 17/60

(52) U.S. Cl. 705/1

(57) ABSTRACT

### Abstract of the Disclosure

A system for providing information from a server array to at least one remote computer includes a server array having server computers, databases, and computer software programs. The remote computers also include the software programs. The remote computers communicate with the server array and the server array provides information to the remote computers, based on information sent by the remote computers, by a website or output data. The information provided from the server array may be order information, alert information specified by a user of the remote computers, or the like.

### Detailed Description of the Invention

### Cross Reference to Related Applications

This application claims the benefit of U.S. provisional patent application Serial No. 60/444,168, filed January 31, 2003. This application also claims the benefit of U.S. provisional patent application Serial No. 60/444,304 filed January 31, 2003.

### Background of The Invention

The present invention relates generally to e-commerce and electronic ordering and, in particular, to an apparatus and method utilizing an electronic ordering and alert system for the hair replacement industry.

In the hair replacement industry, an order for a product, such as a wig, hairpiece, or the like, is typically placed at a hair salon. The order is then sent to a distributor, who sends the order to a factory. The factory then completes the order and sends the ordered product to the hair salon. During each step of the order and fulfillment process, however, only those parties who have the order or product at that step have access to the order status. Should the hair salon wish to know when the order will be shipped, or from which factory the order will be shipped, the hair salon needs to contact the distributor, who must look up the order, gather any pertinent information from the factory, call the factory and get an update on the order, and then provide the information to the hair salon. This can be a very time-consuming and time-wasting process for all parties who have an interest in the order.

In addition, in many industries, and in the hair replacement industry in particular, it is known to maintain a database of product information as well as a database of customer information. The product information database typically includes the products that a company offers as well as other product information including current inventory, production status, and cross-referencing information for the products. The customer database typically includes customer identification, contact information, financial information such as credit cards and the like, as well as customer preferences, and other customer-specific information. Product and customer administration software utilizes information in each of the databases to provide updates to customers and prompt the customers regarding, for example, future sales and new product offers.

It is desirable, therefore, to provide an improved means for ordering, tracking, and fulfilling orders, such as in the hair replacement industry, wherein all parties with an interest in the order may have access to the order status.

It is also desirable to utilize the information in databases and in other sources of information to streamline the customer administration process. It is also desirable to provide an improved means for utilizing the information in both the customer database and the product database to increase productivity for the provider of services and provide better service to the customer.

### Summary of The Invention

An electronic ordering system in accordance with the present invention includes at least one server computer for maintaining a database of product and order information. A first remote computer is in communication with the at least one server for use by a retailer of the product and is operable to generate an order for the product to the at least one server, the at least one server generating an updated order from the order. A second remote computer is in communication with the at least one server for use by a distributor of the product and being operable to receive the updated order from the at least one server, process the updated order and to send a revised order to the at least one server, the at least one server generating another updated order from the revised order. A third remote computer is in communication with the server array for use by a factory manufacturing the product and being operable to receive the another updated order, process the another updated order and to send an order update to the at least one server whereby the at least one server stores the order, the updated order, the revised order, the another updated order and the order update as the order information.

An alert system in accordance with the present invention includes at least one computer having a software program running thereon at a retailer, a server array having at least one server computer, the server array in communication with the at least one retailer computer. A database is stored in the server array and has information stored therein. Alert preference information is stored in the server array and includes information stored therein. A business logic processor thread software program running on the at least one server computer is operable to gather the information in the database and access the alert preference information. When the business logic processor thread accesses the alert preference information and gathers the information from the database based on the alert preference information, the business logic processor thread sends the gathered information to the at least one computer. When the at least one computer receives the gathered information, the software program displays the gathered information in at least one user interface.

### Description of The Drawings

The above, as well as other advantages of the present invention, will become readily apparent to those skilled in the art from the following detailed description of a preferred embodiment when considered in the light of the accompanying drawings in which:

Fig. 1 is a block diagram of an electronic ordering and alert system in accordance with the present invention;

Fig. 2 is a schematic view of the electronic ordering system in accordance with the present invention; and

Fig. 3 is a flow chart of the operation of the electronic alert system in accordance with the present invention.

### Detailed Description of the Preferred Embodiment

Referring now to Fig. 1, a general architecture of an electronic ordering and alert system in accordance with the present invention is indicated generally at 10. The system 10 includes a server array, indicated generally at 12. The server array 12 preferably includes a plurality of servers 14 connected by an internal network 16, such as an intranet or the like. A plurality of databases 18 containing information, including product information, customer information and the like is stored in at least one of the servers 14 in the server array 12. At least one computer program 20, such as a product ordering program, a customer alert program, or the like, is running on the server array 12.

The server array 12 is in communication with an interface 22. Preferably, the interface 22 is a secure website accessible by a network 24, such as the Internet. Preferably, the website 22 and/or the server array 12 includes user verification, secure login, or certificate key functions or similar security measures to prevent unauthorized access to the server array 12 via the Internet 24.

At least one remote workstation computer 26 is connected to the secure website 22 via the Internet 24. The workstation computer 26 may be located remote from the server array 12 such as at a retail store, home office, or the like. At least one remote distributor computer 28 is connected to the secure website 22 via the Internet 24. The distributor computer 28 may be located remote from the server array 12 such as at a distribution warehouse or the like. At least one remote factory computer 30 is connected to the secure website 22 via the Internet 24. The factory computer 30 may be located remote from the server array 12 such as at a factory office, factory shop floor, or the like. At least one remote user computer 32 is connected to the secure website 22 via the Internet 24. The user computer 32 may be located remote from the server array 12 such as at an office building, home office, or the like. The remote computers 26, 28, 30, and 32 have at least one of the computer software programs 20 running thereon. The remote computers 26, 28, 30, and 32, although each is in communication with the server array 12, are not in communication with each other. The website 22 is preferably specific to the type of program 20 being used to communicate with the server array 12. The remote computers 26, 28, 30, and 32 may be a server computer, a desktop personal computer, a laptop personal computer, a mobile telephone, a personal digital assistant (PDA) or similar device able to connect to, communicate with, and display information from the Internet 24. Alternatively, the remote computers 26, 28, 30, and 32 could connect with the server array 12 via a direct connection 24a, such a direct dial-in network connection or the like and thereby bypass the website 22.

The remote computers 26, 28, 30, and 32 are operable to send and receive information from the server array 12 through the website 22. The display of the website 22 may be varied depending on the type of software program 20 running on the remote computers 26, 28, 30, and 32. The information sent and received via the website 22 is preferably information and/or data related to the software programs 20 or the databases 18. The software programs 20 on the server array 12 are operable to provide information to and retrieve information from the databases 18, depending on the requirements of the users of the remote computers 26, 28, 30, and 32. Preferably, one of the databases 18 includes user profile information on each of the users of the system 10. For example, each user of the system 10 is given a global identifier (GID) with which they may access the server array 12 of the system 10 via the interface 22, which aids in providing security to the system 10. The GID, along with other factors including, but not limited to a user profile configured in a one of the databases 18 and the like, will determine the access to the information in the databases 18 provided to the user of the program 20 when accessing the website 22. The information displayed on the website 22, therefore, may be dependent on the type of program 20 running on the computers 26, 28, 30, or 32. Alternatively, the computers 26, 28, 30, or 32 do not have a software program 20 running thereon and communicate solely via the website 24.

Based on the information sent by the computers 26, 28, 30, and 32 and received by the server array 12, the software programs 20 provide information to the users of the computers 26, 28, 30, and 32. The software programs 20 on the server array 12 are operable provide output data or information in a variety of formats. Preferably, the information is retrieved from at least one of the databases 18. The databases 18 may contain, but is not limited to, tables of static information, tables of frequently or infrequently updated data, or tables of data mined from public or private sources internal or external to the server array 12, based upon request of the users of the computers 26, 28, 30, and 32. The software programs 20 may provide information directly via the website 22, based on interactions with users at the website 22. Alternatively and/or in addition to information provided on the website 22, the software programs 20 provide information via a read-only output 34 including, but not limited to, fax messages, e-mail messages, and text messages sent to a mobile telephone. The software programs 20 on the computers 26, 28, 30, and 32 are operable to display the data sent to the website 22 on the computers 26, 28, 30, and 32. Depending on the type of output 34, for example a text attachment to the e-mail message or the like, the programs 20 on the computers 26, 28, 30, and 32 may also be able to display the information from the output 34. If the computers 26, 28, 30, and 32 have the same program 20 running thereon, the users of the computers 26, 28, 30, and 32 will be able to access the same information, depending on their user profile. Preferably, the programs 20 also provide a means for alerting users of the program 20 that the output 34 is available for viewing.

Depending on their user profile configuration, the users of the computers 26, 28, 30, and 32 may be able to edit the data displayed in the program 20 or the website 22, which will update information in the appropriate database 18. Depending on the type of software program 20 and on the relationship of the users of the software program 20, the administrator of the server array 12 may provide the users of the computers 26, 28, 30, and 32 the ability to configure what information in the databases 18 is operable able to be displayed for other users of the program 20. For example, if provided by the administrator of the server array 12, a user at the factory computer 30 could provide full information to users at the distributor computer 28 but could provide more limited access to users at the workstation computer 26 and the user computer 32, located at an office of an agent, a sales representative, or the like.

Other software programs 20 do not provide access to any information in the databases 18 other than through the read-only output 34. For example, users of a software program 20 requesting mortgage rate information will only receive information via one or many of the various outputs 34 when the program 20 has determined, based on information supplied to the program by the user, that the information meets the user's requirements. In addition, those skilled in the art will realize that any number of computers, such as the computers 26, 28, 30, and 32 may be in communication with the server array 12 while remaining within the scope of the present invention.

Referring now to Fig. 2, an electronic ordering system, such as for the hair replacement industry, in accordance with the present invention is indicated generally at 100. The electronic ordering system 100 includes a software program (not shown), such as a one of the software programs 20 shown in Fig. 1, running on at least one computer 112 at a salon or retailer 114. The software program of the electronic ordering system 100 is also running concurrently on at least one computer 116 at a distributor 118, on at least one computer 120 at a first factory 122, on at least one computer 124 at a second factory 126, and on at least one server computer 128 in a server array 130. Preferably, the software program of the electronic ordering system 100 is running on at least one computer at a plurality of distributors, such as the distributor 118. Preferably, the server array 130 includes at least two server computers 128 interconnected by a network (not shown). The at least two server computers 128 may or may not be located at the same physical location. Preferably, the at least two server computers 128 provide backup services for one another in the event of a failure of a one of the server computers 128. The server computers 128 of the server array 130 are in communication with the respective computers 112, 116, 120, and 122 of the retailer 114, the distributor 118, and the factories 124 and 128 by a network such as the world wide web (not shown) or the like. The software program of the electronic ordering system 100 is operable to produce, track, and update orders for hair replacement products (not shown) and/or other similar products, discussed in more detail below.

In operation, a user (not shown) at the retailer 114 enters an order for a product (not shown) such as a hair replacement product or similar product into the computer 112. The software program on the computer 112, in a step 132, generates an order 134 and transmits the order 134 to the server array 130. The order 134 can include information such as an order form 136, along with other data such as an "order priority" flag 138 and an "order cancel" flag 140. The order form 136 can be a proprietary electronic order form for the distributor 118. Preferably the order form 136 of the software program includes rules to ensure that the order 134 is free from incompatibilities prior to being sent to the server array 130. The server array 130 receives the order 134 and stores the information from the order 134 in the server computers 128, such as for example, as a record in a database (not shown). The software program on the server computers 128, utilizing the information from the order 134, in a step 142, sends another or updated order 144 to the distributor 118. The order 144 can include an updated order form 136 and a "status update" field 146.

Preferably, the order 134 is stored in an order database (not shown), such as a one of the databases 18 shown in Fig. 1, on the server computers 128 in the server array 130. The user, when entering the order information, completes data entry for a few of the fields in a new record in the order database, which is then uploaded to the server array 130. When the new record is received by the server array 130, the servers 128 of the server array 130 update other fields in the record and append it to the database. After uploading the data, the user is preferably unable to make changes to all but a few fields in the order record 134 including, but not limited to, canceling the order by updating the order cancel flag 140. Preferably, the record in the database is tracked by assigning to the record a unique global database identifier (GDID), which will remain with the record throughout its existence in the database. The order 134 may be verified by comparison to a product database in the server array 130. The servers 128 administer the databases and provide redundant and secure access to the orders, such as the order 134, in the order database via suitable security-protected access, including but not limited to order form viewing and the like.

The computer 116 of the distributor 118 receives the order 144 and processes the order 144, providing additional information into the order 144 as necessary. In a step 148, the computer 116 sends a revised processed order 150 to the server array 130. The processed order 150 can include fields or flags such as an "order received from" field 152, a "review order" flag 154, an "order declined" flag 156, an "order accepted" flag 158, an "order assigned to suggested factory" flag 160, and an "order assigned to required factory" flag 162. Preferably, the processed order 150 is an updated record of the order 134.

The server array 130 receives the processed order 150 and stores the information from the processed order 150 in the server computers 128. Preferably, the information from the processed order 150 is stored in the server computers 128 as an updated record in the database from the orders 134 and 144.

Based on the information in the processed order 150, the server array 130, in a step 164 or in a step 166, sends an updated order 144' or 144'' having an updated order form 136' or 136'' and an updated "status update" flag or field 146' or 146'' to either the first factory 122 or the second factory 126. Preferably, the server array 130 sends the updated order 144' to either the first factory 122 or the second factory 126 based on the information in the processed order 150 including the "order assigned to suggested factory" field 160 and the "order assigned to required factory" field 162.

If the first factory 122 receives the updated order 144', the first factory 122, in a step 168, sends an order update 170 to the server array 130. The order update 170 can include fields or flags such as the "order received from" field 152, an "order approved" field 172, the "order declined" field 156, an "order assigned to factory" field 174, an "order received" field 176, an "order shipped" field 178, the "order assigned to suggested factory" field 160, and the "order assigned to required factory" field 162. Preferably, the order update 170 is an updated database record of the orders 134, 144, 144', and 150.

If the second factory 126 receives the updated order 144'', the second factory 126, in a step 180, sends an order update 182 to the server array 130. The order update 182 can include fields or flags such as the "order received" field 152, the "order approved" field 172, the "order declined" field 156, an "order production status" field 184, an "order completed" field 186, and the "order shipped" field 178. Preferably, the processed order 182 is an updated database record of the orders 134, 144, 144'', and 150.

The server array 130 receives the order update 170 or 182 and stores the information from the order update 170 or 182 in the database in the server computers 128. Preferably, the information from the order update 170 or 182 is stored in the server computers 128 in the same record in the database as the information from the orders 134, 144', and 144'' and the processed order 150.

While the orders 134, 144, 144', and 144'' are in process, the server array 130 provides the ability for users of the respective computers 112, 116, 120, and 122 of the retailer 114, the distributor 118, and the factories 124 and 128 to access the database on the server computers 128 in order to receive a status update on the orders 134, 144, 144', and 144''. For example, a user (not shown) of the computer 112 at the retailer 114 may query the database on the server array 130 in a manner similar to submitting an order in the step 132. Upon receiving the query, the server array 130, in a step 188, provides a message 190 having an "order status" field 192, which is similar to the "order status" field 146, to the retailer 114. Similarly, the distributor 118, the first factory 122 and the second factory 126 may also query the database (not shown) and the server array 130 will provide an order status (not shown) similar to the order status 192, 146, 146', or 146''.

In addition, the each of the users of the system 100 will have a Global Identification (GID), which is a part of a unique user profile in order to enable administrators of the system 100 to increase or reduce the amount of access to the database for each user. In addition, those skilled in the art will realize that any number of computers, such as the computers 112, 116, 120, and 122 may be in communication with the server array 130 while remaining within the scope of the present invention. Although the electronic ordering system 100 according to the present invention has been described in the context of the hair replacement industry, the electronic ordering system 100 may be advantageously utilized for products, services, and industries suitable for conducting business via the Internet.

Referring now to Fig. 3, a method of operation of an electronic alert system for the hair replacement industry in accordance with the present invention is indicated generally at 210. The electronic alert system 210 includes software (not shown), such as a one of the software programs 20 shown in Fig. 1, running on at least one server computer (not shown) in a server array, indicated schematically at 212. Preferably, the server array 212 includes at least two server computers, such as the server computers 14 shown in Fig. 1 or the server computers 128 shown in Fig. 2. The server computer or computers of the server array 212 are in communication with at least one computer, indicated schematically at 214, located at a salon or store (not shown) by a network such as the Internet (not shown), such as the network 24 shown in Fig. 1, or the like. The server array 212 and the at least one computer 214 are separated by a firewall or thread boundary 216 or a similar type security separation, across which the network connects the server array 212 and the at least one computer 214. The server computer or computers of the server array 212 includes a database 218, such as the database 18 shown in Fig. 1, that contains stored information (not shown) such as, but not limited to, product information, customer information, previous purchase information, product expiration intervals, product upgrade offers, customer preferences and the like.

The software of the electronic alert system 210 includes a software program, such as a one of the software programs 20 shown in Fig. 1, known as a business logic processor thread 220 running thereon that utilizes SQL Queries, Views, and Artificial Intelligence logic to obtain information from the database 218. In addition, the business logic processor thread 220 also incorporates alert preferences 222, which are set by the user, in order to obtain information from the database 218. The alert preferences 222, the boundaries of which are specified by an administrator (not shown) of the electronic alert system 210, contain information stored in, for example, a database (not shown), such as a one of the databases 18 shown in Fig. 1. The alert preference information 222 can include, but is not limited to, a refresh interval preference, a date interval preference, an alert type preference, as well as other personal alert preferences for each customer. The business logic processor thread 220 runs in an iterative manner at a predetermined period of time, which is determined and configured by the administrator of the electronic alert system 210 based on the alert preferences 222 set by the users. The administrator also preferably configures the business logic processor thread 220 to run at a specified time interval, such as daily, weekly, or monthly, based on the alert preferences 222 set by the users. Advantageously, more than one business logic processor thread 220 may be run on the server array 212 to produce various types of alert data, discussed in more detail below. The at least one computer 214 has a software program (not shown), such as a one of the software programs 20 shown in Fig. 1, running thereon for receiving and displaying the alert data, discussed in more detail below.

In operation, the business logic processor thread 220 incorporates information from the alert preferences 222 in a step 224. Alternatively, the information from the alert preferences 222 is incorporated as a part of the business logic processor thread 220. The business logic processor thread 220 then utilizes the alert preferences 222, and the SQL Queries, Views, and Artificial Intelligence logic to obtain information from the database 218 in a step 226. After the information is gathered in the step 226, the business logic processor thread 220 organizes and stores the gathered information as a collection of alert data 230 and, in a step 228, sends the alert data 230 across the thread boundary 216 to the computer 214. Alternatively, only a read-only display information, discussed in more detail below, is sent to the computer 214. The alert data 230 is preferably in a non-modifiable query table output from the database 218, or any other type of output data, such as the output 34 shown in Fig. 1.

Preferably, the alert data 230 is organized to include at least one alert type 232. Each of the alert types 232 can be organized to include at least one alert row 234 that contains information specific to the customer. Each of the alert types 232 can also be organized to contain an alert category 236. Preferably, the software program is operable to display the alert data 230 at the computer 214 in a step 238 or in a step 240 on a user interface 242 and/or 244. The user interface 242 may be located at the computer 214 while the user interface 244 may be located at another computer (not shown) or vice versa. The alert types 232 can include information such as, but not limited to, a credit card expiration information 233 and a program expiration information 235. The alert rows 234 can include information such as, but not limited to, information specific to the customer. For example, a user (not shown) of the computer 214 in the user interface 244 can 'mouse over' or click the alert rows 234 of the program expiration information 235 and obtain further information on the result row 234 including, but not limited to, client information 246, a print option 248 to print at least one client letter 249, and the ability to refresh/update the screen 250.

The software program of the system 210 may be advantageously distributed to a plurality of users of the program, enabling each of the users to customize their alert preferences 222 to obtain the desired alert data 230. In addition, the each of the users of the system 210 will have a Global Identification (GID), such as the GID described in the system 100 of Fig. 2, which is a part of a unique user profile in order to enable administrators of the system 210 to increase or reduce the amount of access to the database 218 for each user. Those skilled in the art will appreciate that the alert data 230 may be organized and displayed in numerous ways by the software program while remaining within the scope of the present invention. In addition, although the electronic alert system 210 according to the present invention has been described in the context of the hair replacement industry, the electronic alert system 210 may be advantageously utilized for numerous products, services, and industries suitable for conducting business via the Internet including, but not limited to mortgage rate alert information and the like.

In accordance with the provisions of the patent statutes, the present invention has been described in what is considered to represent its preferred embodiment. However, it should be noted that the invention can be practiced otherwise than as specifically illustrated and described without departing from its spirit or scope.

What is Claimed is:

1. An electronic ordering system, comprising:
at least one server computer for maintaining a database of product and order information;
a first remote computer in communication with said at least one server for use by a retailer of the product and being operable to generate an order for the product to said at least one server, said at least one server generating an updated order from the order;
a second remote computer in communication with said at least one server for use by a distributor of the product and being operable to receive the updated order from said at least one server, process the updated order and to send a revised order to said at least one server, said at least one server generating another updated order from the revised order; and
a third remote computer in communication with said server array for use by a factory manufacturing the product and being operable to receive the another updated order, process the another updated order and to send an order update to said at least one server whereby said at least one server stores the order, the updated order, the revised order, the another updated order and the order update as the order information.

2. The electronic ordering system according to claim 1 wherein said at least server limits access of said first, second and third remote computers to different portions of the order information.

3. The electronic ordering system according to claim 1 wherein said at least one server communicates with said first, second and third remote computers via an Internet website.

4. The electronic ordering system according to claim 1 wherein the order, the updated order, the revised order, the another updated order and the order update are communicated as messages including an electronic order form and at least one of a flag and a field.

5. The electronic ordering system according to claim 4 wherein said flag is a one of an order received flag, an order accepted flag, an order declined flag, and an order approved flag.

6. The electronic ordering system according to claim 4 wherein said field is a one of an order approved field, an order production status field, an order completed field, and and order shipped field.

7. The electronic ordering system according to claim 1 including a fourth remote computer in communication with said at least one server for use by a user of the product to request and receive a status update based upon the order information.

8. The electronic ordering system according to claim 7 wherein said at least one server limits access of said fourth remote computers to different portions of the order information.

9. A method for ordering hair replacement products, comprising the steps of:
a) providing a first computer at a hair replacement product retailer and generating an order for a hair replacement product from the first computer;
b) providing a server for maintaining a database of order information;
c) communicating the order from the first computer to the server, storing the order as a portion of the order information and generating an updated order from the server;
d) providing a second computer at a hair replacement product distributor, communicating the updated order from the server to the second computer, processing the updated order and generating a revised order from the second computer;
e) communicating the revised order from the second computer to the server, storing the revised order as a portion of the order information, and generating another updated order from the server;
f) providing a third computer at a factory, communicating the another updated order from the server to the third computer, processing the another updated order and generating a order update from the third computer;
g) communicating the order update from the third computer to the server and storing the order update as a portion of the order information; and
h) providing limited access to the order information through each of the first, second and third computers.

10. An electronic alert system for the hair replacement industry, comprising:
at least one computer having a software program running thereon at a retailer;
a server array having at least one server computer, said server array in communication with said at least one retailer computer;
a database stored in said server array and having information stored therein;
an alert preference information stored in said server array and having information stored therein;
a business logic processor thread software program running on said at least one server computer, said business logic processor thread operable to gather the information in said database and access said alert preference information,
whereby when said business logic processor thread accesses said alert preference information and gathers the information from said database based on said alert preference information, said business logic processor thread sends the gathered information to said at least one computer, and
whereby when said at least one computer receives the gathered information, the software program displays the gathered information in at least one user interface.

11. The electronic alert system according to claim 10 wherein said at least one retailer is a plurality of retailers.

12. The electronic alert system according to claim 10 wherein said business logic processor thread utilizes SQL Queries, Views, and Artificial Intelligence logic to obtain the information from said database.

13. The electronic alert system according to claim 10 wherein said alert preference information is provided to said server array by a user of said at least one computer.

14. The electronic alert system according to claim 10 wherein including a thread boundary between said server array and said at least one computer.

15. The electronic alert system according to claim 10 wherein said gathered information is alert data having at least one alert type having at least one result row.

16. The electronic alert system according to claim 15 wherein said at least one alert type includes at least one alert category.

17. A method for providing an alert to a user of a software program in the hair replacement industry, comprising the steps of:
a) providing at least one computer having a software program running thereon at a hair retailer;
b) providing a server array having at least one server computer having the software program running thereon, said server array in communication with said at least one computer at retailer;
c) providing a database stored in said server array and having information stored therein;
d) providing an alert preference information stored in said server array and having information stored therein;
e) providing a business logic processor thread software program running on said at least one server computer, said business logic processor thread operable to gather the information in said database and access said alert preference information;
f) accessing said alert preference information by said business logic processor thread;
g) gathering the information from said database based on said alert preference information by said business logic processor thread;
h) sending the gathered information from said server array to said at least one computer; and
i) displaying the gathered information on said at least one computer in a user interface.
